(19) United States
(12) Patent Application Publication
(10) Pub. No.: US 2025/0073763 A1
(43) Pub. Date: Mar. 6, 2025

(54) SYSTEMS FOR GROUNDWATER REMEDIATION AND METHODS OF GROUNDWATER REMEDIATION IN GEOLOGICAL FORMATIONS

(71) Applicant: Saudi Arabian Oil Company, Dhahran (SA)

(72) Inventors: Zeyad Tareq Ahmed, Chassell, MI (US); Serguey Viktorov Arkadakskiy, Edmonton (CA); Noushad Kunnummal, Louisville, KY (US); Ali H. Al Shamrani, Dammam (SA)

(73) Assignee: Saudi Arabian Oil Company, Dhahran (SA)

(21) Appl. No.: 18/239,984

(22) Filed: Aug. 30, 2023

(51) Int. Cl. B09C 1/00; C02F 1/72; C02F 1/78

(52) U.S. Cl. CPC B09C 1/002; C02F 1/727; C02F 1/78; B09C 2101/00; C02F 2103/06; C02F 2209/22; C02F 2209/23; C02F 2307/00

(57) ABSTRACT

This disclosure relates to systems for remediation of groundwater in geological formations and methods of groundwater remediation in geological formations. The system can include a wellbore within a geological formation comprising an aquifer, a casing, inner tubing, a water passage, outer tubing comprising a plurality of diffusion membranes, and a formation conduit in fluid communication with the aquifer. The method may include forming a dissolved remediation gas solution within a wellbore by: passing remediation gas through an inner tubing, passing an aqueous solution into the wellbore through a water passage and an outer tubing comprising a plurality of diffusion membranes, and passing the remediation gas through the diffusion membranes to be mixed with the aqueous solution in the outer tubing to produce the dissolved remediation gas solution; and transporting at least a portion of the dissolved remediation gas solution to an aquifer within the geological formation.

### FIELD

Embodiments disclosed herein generally relate to groundwater remediation, and more specifically, to groundwater remediation in geological formations.

### TECHNICAL BACKGROUND

Contamination of groundwater within geological formations pose health risks where the groundwater is used for irrigation or drinking water. Remediation of groundwater within geological formations is desired. Remediation gases can be used to reduce a concentration of contaminants in the groundwater. Accessing groundwater within a geological formation can require drilling a hole from the surface to the geological formation. Specialized drilling techniques and materials are utilized to form the wellbore hole. A wellbore is a hole that extends from the surface to a location below the surface to permit access to formations. The wellbore contains at least a portion of a fluid conduit that links the interior of the wellbore to the surface. The fluid conduit connecting the interior of the wellbore to the surface may be capable of permitting regulated fluid flow from the interior of the wellbore to the surface and can permit access between equipment on the surface and the interior of the wellbore. The fluid conduit may be defined by one or more tubular strings, such as casings, inserted into the wellbore and secured in the wellbore.

### SUMMARY

Conventional methods for groundwater remediation include pump and treat methods, which may require pumping contaminated groundwater to the surface, treating the contaminated groundwater at the surface using expensive surface reactors, and then transporting the treated groundwater back to the aquifer. There is a need for alternative methods for groundwater remediation. Groundwater remediation in geological formations can include dissolving remediation gas in injection fluid, such as an aqueous solution to form a dissolved remediation gas solution and injecting the dissolved remediation gas solution into the geological formations. The systems and methods used can affect a concentration of the remediation gas in the dissolved remediation gas solution and the resulting groundwater remediation. As is described herein, embodiments include diffusion membranes positioned within a wellbore operable to permit remediation gas flow into an aqueous solution stream and deliver aqueous remediation gas solutions into aquifers for groundwater remediation. Embodiments described herein can be used for in-situ groundwater remediation and may increase a concentration of remediation gas into an aqueous solution stream, which may contact the aquifer, thereby delivering an increased concentration of remediation gases to the aquifer.

According to one or more embodiments of the present disclosure, a system for groundwater remediation in a geological formation can comprise a wellbore disposed within the geological formation, the geological formation comprising an aquifer; a casing disposed within the wellbore; inner tubing centrally disposed within the wellbore and extending downhole a depth within the wellbore, the inner tubing being a pathway for remediation gas; a water passage, the water passage being a pathway for delivering an aqueous solution; outer tubing in fluid communication with and disposed about the inner tubing, the outer tubing comprising a plurality of chambers and a plurality of diffusion membranes disposed proximate or within the chambers, wherein the diffusion membranes are configured to selectively permit remediation gas flow into an aqueous solution stream comprising at least a portion of the aqueous solution flowing within the outer tubing to thereby facilitate dissolution of the remediation gas within the aqueous solution; and a formation conduit in fluid communication with the aquifer, configured to deliver the solution of dissolved remediation gas in the aqueous solution stream to the aquifer for groundwater remediation.

According to one or more embodiments of the present disclosure, a method of groundwater remediation in a geological formation may comprise: forming a dissolved remediation gas solution within a wellbore by: passing remediation gas through an inner tubing, passing an aqueous solution into the wellbore through a water passage and an outer tubing comprising a plurality of diffusion membranes, and passing the remediation gas through the diffusion membranes to be mixed with the aqueous solution in the outer tubing to produce the dissolved remediation gas solution; and transporting at least a portion of the dissolved remediation gas solution to an aquifer within the geological formation.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### BRIEF DESCRIPTION OF DRAWINGS

The following detailed description may be better understood when read in conjunction with the following drawings, in which:

FIG. 1 schematically depicts a system for groundwater remediation, according to embodiments as described herein;

FIG. 2 schematically depicts a system for groundwater remediation, according to embodiments as described herein;

FIG. 3 schematically depicts a system for groundwater remediation, according to embodiments as described herein;

FIG. 4 schematically depicts a system for groundwater remediation, according to embodiments as described herein;

FIG. 5 schematically depicts a membrane unit, according to embodiments as described herein; and

FIG. 6 schematically depicts a membrane unit, according to embodiments as described herein.

### DETAILED DESCRIPTION

The present disclosure is generally directed to systems for in-situ groundwater remediation in a geological formation and methods of in-situ groundwater remediation in a geological formation. The systems may generally include a wellbore disposed within a geological formation, the geological formation comprising an aquifer, a casing disposed within the wellbore, inner tubing centrally disposed within the wellbore and extending downhole a depth within the wellbore, where the inner tubing can be a pathway for remediation gas, a water passage, the water passage being a pathway for delivering an aqueous solution, outer tubing in fluid communication with and disposed about the inner tubing, the outer tubing comprising a plurality of chambers and a plurality of diffusion membranes disposed proximate or within the chamber, and a formation conduit in fluid communication with the aquifer. The methods may generally include forming a dissolved remediation gas solution within a wellbore, and transporting at least a portion of the dissolved remediation gas solution to an aquifer within the geological formation. According to some embodiments, such systems and methods may be particularly well suited for groundwater remediation in geological formations.

As used throughout this disclosure, the term “wellbore” refers to a bored well within a formation capable of receiving injection water or other aqueous solutions. The wellbore can be vertical, horizontal, or positioned at any angle within the formation. A wellbore forms a pathway capable of permitting both fluids and apparatus to traverse between the surface and the formation. Besides defining the void volume of the wellbore, the wellbore wall also acts as the interface through which fluid can transition between the subterranean formation and the interior of the wellbore. The wellbore wall can be unlined (that is, bare rock or formation) to permit such interaction with the formation, or lined, such as by a tubular string, so as to prevent such interactions. As used throughout this disclosure, the term “fluid” can include liquids, gases, or both.

As used throughout this disclosure, the term “geological formation” refers to a body of rock that is sufficiently distinctive and continuous that it can be mapped, and can include an aquifer, a rock formation, a rock reservoir, or water containing formation, among others. As used herein, an aquifer refers to a body of rock and/or sediment within a geological formation that holds groundwater.

As used throughout this disclosure, the term “casing” or “cased portion” refers to a portion of the wellbore wherein fluids cannot penetrate the wellbore walls to reach the formation. The casing may include a metallic or non-metallic pipe inside the wellbore. The casing may be centralized within the wellbore. The space between the casing and the wellbore walls may be filled with materials, such as but not limited to cement to ensure well stability and/or zonal insulation. The casing can be disposed within at least a portion of the wellbore.

As used throughout this disclosure, the term “formation conduit” refers to a channel that fluidly connects the wellbore with the surrounding geological formation. A formation conduit can be in fluid communication with the aquifer and be configured to allow fluids, such as a solution of one or more dissolved remediation gases, to be delivered to the aquifer. An “open hole interval portion” refers to a formation conduit, which can comprise an unlined portion of the wellbore wherein fluids can penetrate into the geological formation.

As used throughout this disclosure, the term “membrane unit” refers to a unit able to receive gases, liquids, other fluids, or combinations thereof, and where a gas can diffuse from one portion of the membrane unit to a second portion of the membrane unit. Gas can diffuse through a membrane element, such as a diffusion membrane, when a concentration of the gas is greater in one portion of the membrane unit compared to a second portion of the membrane unit. In embodiments, the diffusion membrane can utilize a single-component membrane, a multicomponent membrane, a selective single-component membrane, a selective multicomponent membrane, or combinations thereof. In embodiments, the diffusion membrane can include a feed side where a gas enters the diffusion membrane, and a permeate side where at least a portion of the gas diffuses into.

As used throughout this disclosure, the term “gas” can refer to any gas or combination of gases. In embodiments, the gas may include, but not be limited to O₂, O₃, H₂, and any other gas or a combination thereof that may support and/or enhance microbially mediated and/or chemical (inorganic) reactions leading to the in-situ remediation of groundwater pollutants. In embodiments, the gas can be a remediation gas. As used throughout this disclosure, the term “remediation gas” refers to any gas or combination of gases that may be used for treating groundwater to reduce a concentration of pollutants in the groundwater.

As used throughout this disclosure, the term “tubing” refers to a pipe, tube, or other enclosed structure. The tube can reside within a wellbore, outside of the wellbore, at a surface of the wellbore, or combination thereof, through which a fluid can be transported.

As used throughout this disclosure, the term “mass transfer rate” can refer to the rate at which a gas can be transported, which can include the transfer of a gas from a gas source into a formation. The mass transfer rate can be influenced by a combination of processes, including but not limited to, advection, dispersion, diffusion, dissolution, and migration of injected solution into the formation. The mass transfer rate may be quantified by measuring the mass of a target gas injected into the wellbore and measuring a mass of the target gas returned to the surface of the formation, and calculating the difference between injected mass and returned mass per unit time.

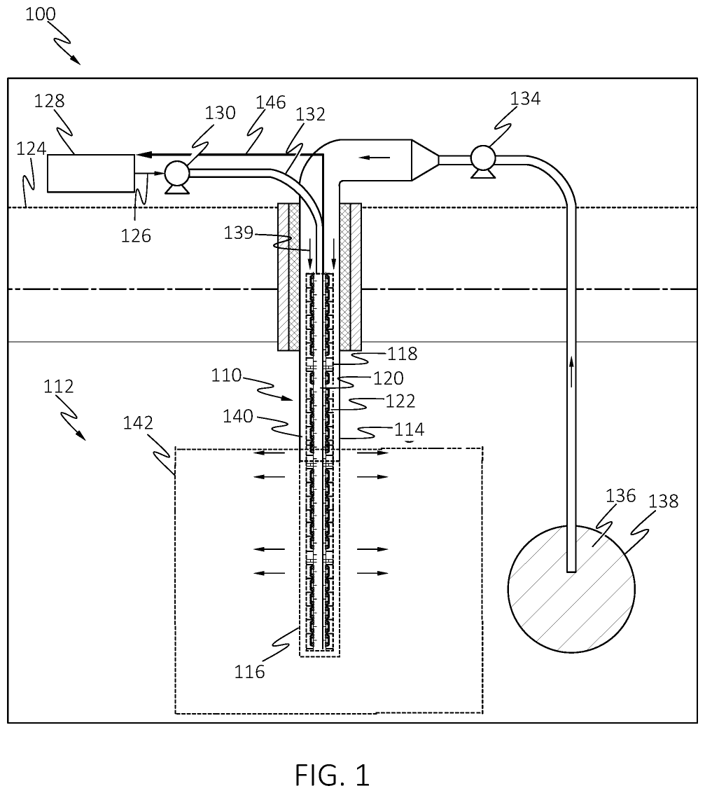

Now referring to FIG. 1, an example system 100 that may be suitable for use with the methods and/or apparatuses described herein is schematically depicted. The system 100 generally comprises a wellbore 110 within a geological formation 112, the geological formation comprising an aquifer, a casing 114 disposed within the wellbore 110, inner tubing 120 centrally disposed within the wellbore 110 and extending downhole a depth within the wellbore 110, a water passage 139 disposed proximate an interior surface of the wellbore 110 and extending downhole a depth within the wellbore 110, outer tubing 118 in fluid communication with and disposed about the inner tubing 120, and a formation conduit, where the formation conduit can comprise an open hole interval portion 116 of the wellbore 110 in fluid communication with a treatment zone 142 of the aquifer in the geological formation 112. In embodiments, the outer tubing 118 can run vertically in the wellbore 110 from a position below a surface 124 of the geological formation 112 within the casing 114, and end near a portion of the wellbore 110 in the open hole interval portion 116 of the wellbore 110. A feed gas stream 126 from a gas source 128 can be transported into the inner tubing 120 using a gas pump 130. The feed gas stream 126 can travel through a pipe 132 fluidly connected to the inner tubing 120. A water pump 134 can be used to pump an aqueous solution 136 within an aqueous solution source 138 in the geological formation 112 to the wellbore 110 through the water passage 139. At least a portion of the aqueous solution 136 in the water passage 139 can form an aqueous solution stream 122 that is fluidly connected to the outer tubing 118. At least a portion of the gas in the inner tubing 120 can flow into the outer tubing 118. The gas can be concentrated in the inner tubing 120, the outer tubing 118, or both the inner tubing 120 and the outer tubing 118. At least a portion of the gas in the outer tubing 120 can flow into the aqueous solution stream 122. At least a portion of the gas in the aqueous solution stream 122 can be dissolved in the aqueous solution stream 122 to form a remediation gas solution 140. The remediation gas solution 140 can flow into the geological formation 112 through the open hole interval portion 116 of the wellbore 110. In embodiments, at least a portion of the gas in the aqueous solution stream 122 can dissolve in the aqueous solution stream 122 after the aqueous solution stream 122 flows into the geological formation 112 to form the dissolved remediation gas solution 140. The treatment zone 142 may be the region of the geological formation 112 that receives the dissolved remediation gas solution 140. In embodiments, the aqueous solution source 138 may be outside of the treatment zone 142, or may be within the treatment zone 142 (not shown). The dissolved remediation gas solution 140 can interact with the aquifer in the treatment zone 142 in the geological formation 112, which may reduce a concentration of pollutants in the aquifer. Additionally, undissolved gases in the outer tubing 118 can be transported to the surface 124 through a gas return pipe 146.

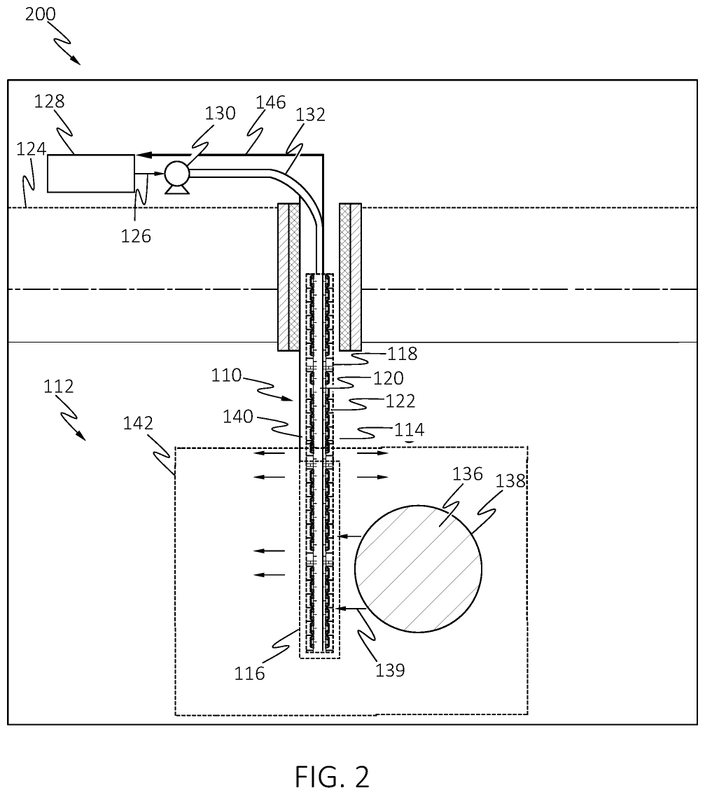

Referring to FIG. 2, an example system 200 that may be suitable for use with the methods and/or apparatuses described herein is schematically depicted. The example system 200 differs from the system 100 of FIG. 1 in that the example system 200 does not include water pump 134, and the aqueous solution 136 from the aqueous solution source 138 passively travels through the water passage 139 to form the aqueous solutions stream 122. That is, in the example system 200, the aqueous solution source 138 is within the treatment zone 142, and the aqueous solution 136 may passively flow from outside of the wellbore 110 into the water passage 139. The passive flow of the aqueous solution 136 into the water passage 139 may be aided by a hydraulic gradient to induce advection of the aqueous solution 136.

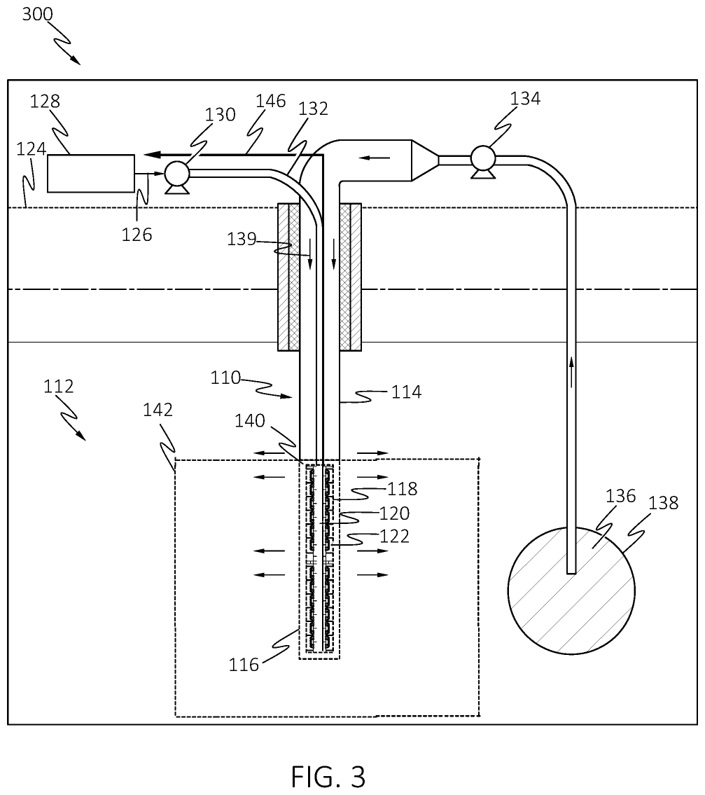

Referring to FIG. 3, an example system 300 that may be suitable for use with the methods and/or apparatuses described herein is schematically depicted. The example system 300 differs from the system 100 of FIG. 1 in that the outer tubing 118 in system 300 is centrally disposed within the open hole interval portion 116 of the wellbore 110, whereas the outer tubing 118 of system 100 is centrally disposed within both the casing 114 and the open hole interval portion 116 of the wellbore 110.

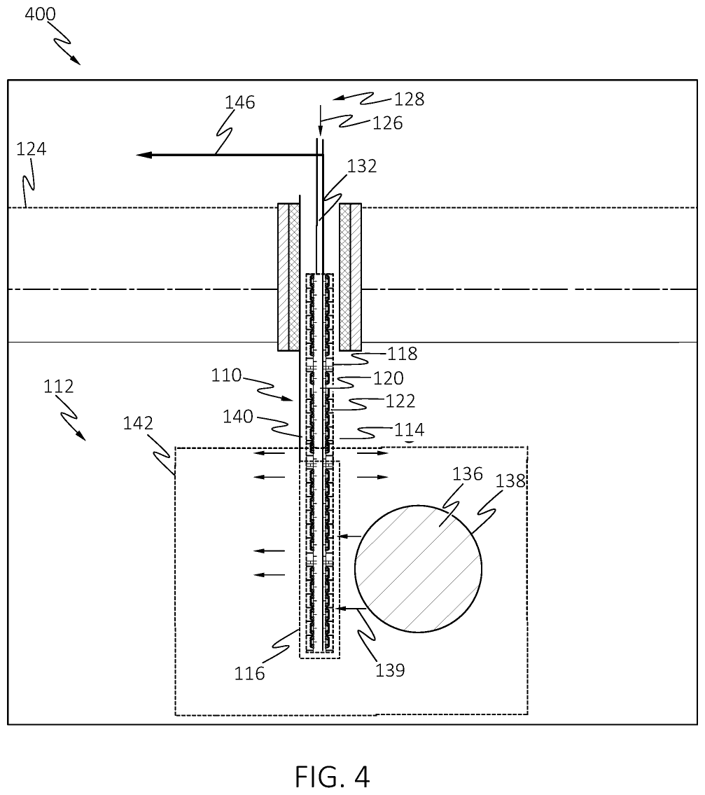

Referring to FIG. 4, an example system 400 that may be suitable for use with the methods and/or apparatuses described herein is schematically depicted. The example system 400 differs from the system 200 of FIG. 2 in that the example system 400 does not include the gas pump 130, and the gas passively travels through the pipe 132 into the inner tubing 120. That is, in the example system 400, the gas source 128 is ambient air that may passively enter the inner tubing 120. The passive flow of the gas into the inner tubing 120 may be aided by advection or diffusion.

The wellbore 110 can include at least a portion of a fluid conduit (not shown) that links the interior of the wellbore 110 to the surface 124. The fluid conduit connecting the interior of the wellbore 112 to the surface 124 can permit regulated fluid flow from the interior of the wellbore 110 to the surface 124 or from the surface 124 to the interior of the wellbore 110. The fluid conduit can permit access between equipment on the surface 124 and the interior of the wellbore 112. Example equipment connected at the surface 124 to the fluid conduit includes pipelines, tanks, pumps, and compressors. The fluid conduit may be large enough to permit introduction and removal of mechanical devices, including but not limited to tools, drill strings, sensors, and instruments, into and out of the interior of the wellbore 110.

In embodiments, the system includes modular components. Suitable modular components include one or more, but not limited to the following: pipes, membrane elements, protective casings, and protective liners. One advantage of having a modular system is that it may be easier and/or cheaper to extract individual modules for maintenance or replacement.

In embodiments, the casing 114 of the wellbore 110 can comprise cement, metal, nonmetallics, or a combination of two or more thereof. In embodiments, the casing 114 can further comprise other equipment, such as but not limited to, packers and spacers. In embodiments, the casing 114 can be operable to prevent fluid flow from the wellbore 110 into the treatment zone 142 of the geological formation 112.

In embodiments, the formation conduit, such as the open hole interval portion 116 of the wellbore 110, can be operable to allow fluids within the wellbore 110, such as the dissolved remediation gas solution 140, to flow out of the wellbore 110 and flow into the treatment zone 142 of the geological formation 112. In embodiments, the open hole interval portion 116 can be absent of any casings, liners, or cement. In other embodiments, the open hole interval portion 116 can include additional support structures, such as slotted liners, casings, or even cement portions. Without being bound by any theory, it is believed that the additional support structures can improve the structural integrity of the open hole interval portion 116, which can increase the length of time the wellbore can be used without repair.

In embodiments, the outer tubing 118 can be positioned within both the casing 114 and the open hole interval portion 116 of the wellbore 110, as shown in system 100. Without intending to be bound by any particular theory, it is believed when the flow rate, or injectivity, of the aqueous solution 136 is high, it can be advantageous for the length of the outer tubing 118 to be positioned within both the casing 114 and the open hole interval portion 116 to accommodate a greater volume of the aqueous solution 136. Without being bound by any particular theory, it is believed that a longer outer tubing 118 spanning both the casing 114 and the open hole interval portion 116 can allow for an increased mass transfer rate of gas into the aqueous solution 136, and thus an increased mass transfer rate of the remediation gas into the geological formation 112.

In embodiments, the outer tubing 118 can be positioned within the open hole interval portion 116 of the wellbore 110, as shown in system 200. Without intending to be bound by any particular theory, it is believed that the positioning of the outer tubing 118 within the open hole interval portion 116 of the wellbore 110 can increase gas solubility, within solubility limits, as the outer tubing 118 is deeper in the well and the pressure and temperature can be higher than a less deep position in the wellbore 110, such as within the casing 114 of the wellbore 110.

In embodiments, the outer tubing 118 can be positioned within the casing 114 of the wellbore 110 (not shown). Without intending to be bound by any particular theory, it is believed that if the flow rate of the aqueous solution 136 into the wellbore 110 is low, a longer outer tubing 118 may not be necessary. As such, the outer tubing 118 can be positioned within the casing 114 of the wellbore 110.

In embodiments, the gas can be from a gas source 128. In embodiments, the gas can be a gas mixture from a gas source 128, such as ambient air, air tank, or oxygen tank. In embodiments, the gas source can be positioned outside of the formation. In embodiments, a gas pump 130 can direct the gas into the wellbore 110. In embodiments, a gas pump 130 can concentrate the gas and can direct it into the wellbore 110. In embodiments, the system does not include a gas pump, and the gas source 128 is ambient air (as shown in FIG. 4). In embodiments, the gas can be directed into the wellbore 110 from a feed gas stream 126. As used in this disclosure, the term “feed gas stream” refers to the composition of gases transported from the gas source 128 to the system. In embodiments, a gas pump 130 can direct the gas into the inner tubing 120 positioned within the wellbore 110. In embodiments, the gas can be transported through a pipe 132. In embodiments, the pipe 132 can have an opening wherein the gas can exit the pipe 132 and the gas can enter the inner tubing 120.

In embodiments, the gas from the gas source 128 can comprise O₂, O₃, H₂, or combinations thereof. In embodiments, the gas from the gas source 128 can comprise O₂. In embodiments the gas source 128 can comprise O₂, O₃, H₂, or combinations thereof. In embodiments the gas source 128 can comprise O₂. In embodiments, the gas from the gas source 128 can be O₂. In embodiments, the gas from the gas source 128 can comprise greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or even greater than or equal to 95 wt. % O₂, based on the total weight of the gas from gas source 128. In embodiments, the gas from the gas source 128 can comprise up to 100 wt. %, up to 95 wt. %, up to 90 wt. %, up to 80 wt. %, up to 70 wt. %, up to 60 wt. %, or even up to 50 wt. % O₂, based on the total weight of the gas from the gas source 128. In embodiments the gas source 128 can comprise O₃. In embodiments, the gas from the gas source 128 can be O₃. In embodiments, the gas from the gas source 128 can comprise greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or even greater than or equal to 95 wt. % O₃, based on the total weight of the gas from gas source 128. In embodiments, the gas from the gas source 128 can comprise up to 100 wt. %, up to 95 wt. %, up to 90 wt. %, up to 80 wt. %, up to 70 wt. %, up to 60 wt. %, or even up to 50 wt. % O₃, based on the total weight of the gas from the gas source 128. In embodiments the gas source 128 can comprise H₂. In embodiments, the gas from the gas source 128 can be H₂. In embodiments, the gas from the gas source 128 can comprise greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or even greater than or equal to 95 wt. % H₂, based on the total weight of the gas from gas source 128. In embodiments, the gas from the gas source 128 can comprise up to 100 wt. %, up to 95 wt. %, up to 90 wt. %, up to 80 wt. %, up to 70 wt. %, up to 60 wt. %, or even up to 50 wt. % H₂, based on the total weight of the gas from the gas source 128. In embodiments, the gas source 128 can be O₂, O₃, H₂, and any other gas or a combination of gases that may support and/or enhance in-situ degradation of groundwater pollutants. In embodiments. The gas from the gas source 128 is selected from the group consisting of O₂, O₃, H₂, and combinations thereof.

In embodiments, a gas filter or gas separator can be used to purify a desired gas from the gas source 128 before introducing the gas to the inner tubing 120. Examples of suitable filter or separation techniques include, but are not limited to cyclones, baghouses, electrostatic precipitators, scrubbers, cryogenic separators, molecular sieves and/or any other gas filtration and separation devices or combinations of two or more thereof.

In embodiments, a gas return pipe 146 can be connected to the wellbore 110. As used throughout this disclosure, the term “gas return pipe” refers to a pipe that is fluidly connected to the wellbore 110 and the surface 124 of the geological formation 112. Insoluble gases, undissolved gases, or both insoluble gases and undissolved gases in the outer tubing 118 can be transported out of the wellbore 110 and to the surface 124 of the geological formation 112 through the gas return pipe 146 as a return gas. The gas return pipe 146 can reside within the wellbore 110. A composition of the return gas can be monitored, further processed, vented, or combinations thereof.

In embodiments, an aqueous solution 136 can be added to the wellbore 110 through the water passage 139 disposed proximate an interior surface of the wellbore 110. In embodiments, the aqueous solution 136 can be sourced from an aqueous solution source 138. In embodiments, a water pump 134 can direct the aqueous solution 136 into the wellbore 110. In embodiments, the water pump 134 can direct the aqueous solution 136 into the outer tubing 118 as the aqueous solution stream 122. In embodiments, the rate of a flow of the aqueous solution 136 into the wellbore 110, the outer tubing 118 as the aqueous solution stream 122, or both, can be changed by modifying the water pump 134 based on the desired flow rate of the aqueous solution 136. In embodiments, the aqueous solution source 138 can be positioned within the geological formation proximate to the wellbore 110 such that the aqueous solution 136 may passively flow into the water passage 139 and enter the outer tubing 118 (as shown in FIGS. 2 and 4).

In embodiments, the aqueous solution 136 can include one or more of deionized, tap, distilled, or fresh waters; natural, brackish, or saturated salt waters; marine waters, natural hydrocarbon formation produced waters, or synthetic brines; filtered or untreated seawaters; mineral waters; treated or untreated wastewater; or other potable or non-potable waters. In embodiments, the aqueous solution 136 can comprise at least 80 wt. %, at least 90 wt. %, at least 95 wt. %, at least 99 wt. %, at least 99.9 wt. % or even 100 wt. % of water.

In embodiments, the aqueous solution source 138 can be positioned within the geological formation 112. In embodiments, the aqueous solution source 138 can originate from the same zone within the geological formation 112 in which the wellbore 110 is located. Without intending to be bound by any particular theory, it is believed that if the aqueous solution source 138 originates within the same zone within the geological formation 112, it may create a hydraulic gradient to facilitate mixing of contaminated water in the aquifer with the injected dissolved remediation gas solution. Further, it is believed that by using the aqueous solution source 138 within the geological formation 112 that is being treated, such embodiments may reduce undesired mineral precipitation or ion exchange reactions that could reduce the pore space inside the aquifer and thus have a negative impact on injectivity. Further, it is believed that sourcing the aqueous solution 136 from the geological formation 112 can prevent overpressure and/or undesired fluid migration outside of the treatment zone 142 and into areas where sensitive receptors (e.g. any natural or human-constructed feature that may be adversely affected by a hazardous material) are present. Additionally, it is believed that sourcing the aqueous solution 136 from the geological formation 112 can improve monitoring of groundwater remediation in the geological formation 112, which may improve the identification of remediation processes and reactions, which could be otherwise obscured by the injection of a chemically different aqueous solution.

In embodiments, the aqueous solution source 138 can be positioned within the treatment zone 142 of the geological formation. In embodiments, the aqueous solution source 138 can be positioned outside of the treatment zone 142 of the geological formation. Without intending to be bound by any particular theory, it is believed that positioning the aqueous solution source 138 outside of the treatment zone 142 may create a stronger local hydraulic gradient within the aquifer, which can further enhance the mixing of the contaminated water in the aquifer with the dissolved remediation gas solution, which may remediation. Injecting an aqueous solution external to the geological formation 112 may also help direct a plume of contaminated groundwater away from area comprising sensitive receptors.

In embodiments, the aqueous solution source 138 can be an aquifer identical to the aquifer the wellbore 110 is positioned within. In embodiments, the aqueous solution source 138 can be a well differing from the aquifer the wellbore 110 is positioned within. For instance, the aqueous solution source 138 can be any well producing water. Without intending to be bound by any particular theory, it is believed that a system for transporting dissolved gases to a formation can be more efficient if the aqueous solution from the wellbore can be recycled back to the aqueous solution source 138.

In embodiments, the outer tubing 118 is positioned within the wellbore 110. In embodiments, the outer tubing 118 can comprise a plurality of diffusion membranes. In embodiments, the membranes can be a single-component membrane, a composite membrane, a selective multicomponent membrane, or combinations of these. As used herein, the term “single-component membrane” can refer to a membrane where the structural elements are made from the same material. As used herein, the term “composite membrane” can refer to a membrane where at least two structural elements of the membrane are made from different materials. As used herein, the term “selective multicomponent membrane can refer to a membrane where at least two structural elements of the membrane are made from different materials and the membrane can be configured to exclude the diffusion of one or more gases and include the diffusion of one or more other gases.

In embodiments, the outer tubing 118 can include a hollow fiber or spiral wound membranes. Hollow fibers can be tubes made of the membrane material. In embodiments, the gas can flow inside the tube and the aqueous solution stream 122 can flow outside the tube. In embodiments, the gas can be enter the membrane at the feed side of the membrane (e.g. inside of tube). In embodiments, the aqueous solution stream 122 can contact the permeate side of the membrane (e.g. outside of tube). The gas can diffuse from inside the tube and can dissolve at the surface outside the tube (permeate side) when it contacts the aqueous solution stream 122. In embodiments, the thickness of the tube, where the gas diffusion can occur is called a “membrane wall”. In embodiments, wound membranes can be combined sheets of membrane, layered with highly porous support plates to allow the flow of gas in one portion of the membrane and the flow of liquid in another portion of the membrane. In embodiments, multiple layers of the membrane sheets and spacers can be rolled into one cylindrical unit. In embodiments, two or more hollow fibers can be connected. Exemplary examples of diffusion membranes can be gas permeable silicone or polydimethylsiloxane (PDMS) membranes.

In embodiments, the outer tubing 118 can include one or more membrane units. The outer tubing 118 can include only one membrane unit, or the outer tubing 118 can include two or more membrane units. The membrane units can be connected in series to form a longer outer tubing 118, in comparison to an outer tubing 118 that includes only one membrane unit. Without intending to be bound by any particular theory, it is believed that configuring the outer tubing 118 to include additional membrane units can increase the interface area, which may increase the mass transfer rate of the system.

In embodiments, the outer tubing 118 can be configured to receive the gas under countercurrent conditions, cocurrent conditions, or a combination thereof.

In embodiments, the aqueous solution stream 122 and the gas can be introduced to the outer tubing 118 such that the gas flows against the flow of the aqueous solution stream 122 under countercurrent conditions. As used throughout the disclosure, the term “countercurrent” or “countercurrent conditions” refers to such embodiments wherein the gas and aqueous solution stream 122 are introduced to the outer tubing 118 in a manner that results in the gas flowing in an opposing direction of the flow of the aqueous solution stream 122.

In embodiments, the outer tubing 118 can be configured to receive the remediation gas under countercurrent conditions. In embodiments, the gas can enter the outer tubing 118 at a lower portion of the outer tubing 118, such as the lower 50% of the outer tubing 118 to the end distal to the surface 124 of the wellbore 110 based on the total length of the outer tubing 118. In embodiments, the gas can enter the outer tubing 118 at the lower 50%, 45%, 40%, 35%, 30%, 25%, 20%, 15%, 10%, 5%, or 1% of the end distal to the surface 124 of the wellbore 110 based on the total length of the outer tubing 118. In embodiments, the gas can be transported through inner tubing 120, where the gas can flow to a lower portion of the outer tubing 118, before the gas reaches a diffusion membrane that interfaces with the aqueous solution stream 122 of the outer tubing 118. Without intending to be bound by any particular theory, it is believed that configuring the outer tubing 118 to receive gas under countercurrent conditions can result in the lowest concentration of gas in the gas stream to be in contact with the aqueous solution stream 122 having a low concentration of gas at the top of the membrane unit. Thus, this configuration can establish a concentration gradient even when the gas has a lower concentration in the gas stream, which may facilitate higher gas transport efficiency from the gas stream, in comparison to a system configured under cocurrent conditions.

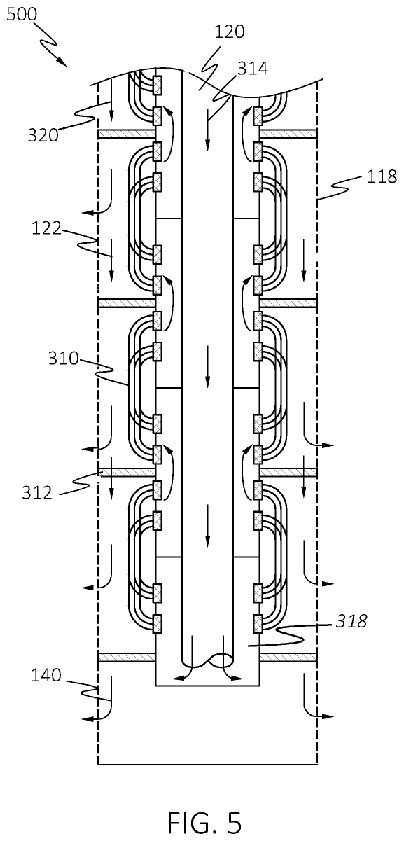

Referring to FIG. 5, a schematic of an exemplary membrane unit 500 configured under countercurrent conditions is depicted. The membrane unit 500 can include the outer tubing 118 and the inner tubing 120. A gas stream 314 that includes a remediation gas can travel within the membrane unit 500. The gas stream 314 can flow through inner tubing 120 to a lower portion of the membrane unit 500 and enter a first gas chamber 318 of outer tubing 118, where the first gas chamber 318 is positioned at the end distal to the surface 124 of the wellbore 110. The aqueous solution stream 122, which can include at least a portion of the aqueous solution 136, can enter a first water chamber 320 of outer tubing 118. One or more diffusion membranes 310 can be configured such that the gas flows inside (feed side) the diffusion membranes 310 and the aqueous solution stream 122 makes contact with an outside portion (permeate side) of the diffusion membranes 310 at a membrane-liquid interface. The gas inside the diffusion membranes 310 can diffuse through the diffusion membranes 310 and enter the water passage stream 122 to form a dissolved remediation gas solution 140. The gas can flow from the first chamber 318 to the additional chambers in series, and the concentration of the gas can be reduced along this path within the gas chambers as more gas is diffused through the diffusion membranes 310 and is transported to the aqueous solution stream 122 along the path of the outer tubing 118. Without intending to be bound by any particular theory, it is believed the concentration of the gas in the gas chambers is the lowest in the gas chamber closest to the surface 124 under countercurrent conditions. The dissolved remediation gas solution 140 can exit the outer tubing 118. The dissolved remediation gas solution 140 can exit the wellbore 110 and enter a geological formation 112 through a formation conduit (not pictured). The undissolved gas in the gas chambers can be transported to the surface 124 for enrichment, disposal, treatment, or a combination thereof (not pictured). The membrane unit 500 can also include one or more spacers 312 to position and/or protect elements of the outer tubing 118. The one or more spacers 312 can also direct the aqueous solution stream 122 and/or the dissolved remediation gas solution 140 to the membrane-liquid interface.

In embodiments, the aqueous solution stream 122 and the gas can be introduced to the outer tubing 118 such that the gas flows with the flow of the aqueous solution stream 122 under cocurrent conditions. As used throughout the disclosure, the term “cocurrent” or “cocurrent conditions” refers to such embodiments wherein the gas and aqueous solution stream 122 are introduced to the outer tubing 118 in a manner that results in the gas flowing in a similar direction of the flow of the aqueous solution stream 122.

In embodiments, the outer tubing 118 can be configured to receive the remediation gas under cocurrent conditions. In embodiments, the gas can enter the outer tubing 118 at an upper portion of the outer tubing 118, such as the upper 50% of the outer tubing 118 to the end proximal to the surface 124 of the wellbore 110 based on the total length of the outer tubing 118. In embodiments, the gas can enter the outer tubing 118 at the upper 50%, 45%, 40%, 35%, 30%, 25%, 20%, 15%, 10%, 5%, or 1% of the end proximal to the surface 124 of the wellbore 110 based on the total length of the outer tubing 118. Without intending to be bound by any particular theory, it is believed that configuring the outer tubing 118 to receive gas under cocurrent conditions can result in a higher concentration gradient over the length of outer tubing 118 and achieve a higher overall mass transfer rate, in comparison to countercurrent conditions.

In embodiments, the dissolved remediation gas solution may comprise O₂, O₃, H₂, or combinations thereof. In embodiments, the dissolved remediation gas solution may comprise greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % O₂, O₃, or H₂, based on the total weight of dissolved gases in the dissolved remediation gas solution. In embodiments, the dissolved remediation gas solution may comprise a total amount of O₂, O₃, and H₂ of greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or greater than or equal to 99 wt. %, based on the total weight of dissolved gases in the dissolved remediation gas solution. In embodiments, the dissolved remediation gas solution may comprise O₂. In embodiments, the dissolved remediation gas solution may comprise greater than or equal to 50 wt. %, greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % O₂, based on the total weight of dissolved gases in the dissolved remediation gas solution.

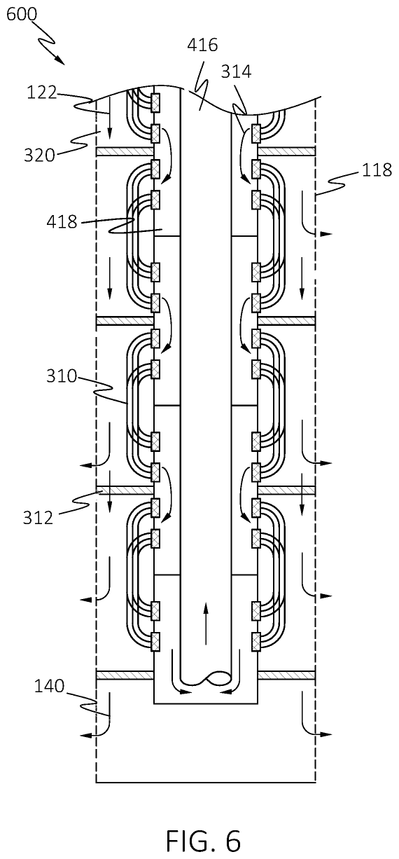

Referring to FIG. 6, a schematic of an exemplary membrane unit 600 configured under cocurrent conditions is depicted. The membrane unit 600 can include the outer tubing 118. A gas stream 314 that includes a remediation gas can travel from inner tubing 120 (not pictured) and enter the membrane unit 600. The gas stream 314 can enter a first gas chamber 418 positioned at the end proximal to the surface 124 of the wellbore 110. The aqueous solution stream 122, which can include at least a portion of the aqueous solution 136, can enter a first water chamber 320 of outer tubing 118. One or more diffusion membranes 310 can be configured such that the gas flows inside the diffusion membranes 310 and the aqueous solution stream 122 makes contact with an outside portion of the diffusion membranes 310 at a membrane-liquid interface. The gas inside the diffusion membranes 310 can diffuse through the diffusion membranes 310 and enter the aqueous solution stream 122 to form a dissolved remediation gas solution 140. The gas can flow from the first chamber 318 to the additional chambers in series, and the concentration of the gas can be reduced along this path within the gas chambers as more gas is diffused through the diffusion membranes 310 and is transported to the aqueous solution stream 122 along the path of the outer tubing 118. Without intending to be bound by any particular theory, it is believed the concentration of the gas in the gas chambers is the lowest in the chamber furthest from the surface 124 under cocurrent conditions. The dissolved remediation gas solution 140 can exit the outer tubing 118. The dissolved remediation gas solution 140 can exit the wellbore 110 and enter a geological formation 112 through a formation conduit (not pictured). After the gas flows through the last diffusion 310 in the last chamber, the undissolved gas in the gas chambers can flow back to the surface 124 through an inner pipe 416 for enrichment, disposal, treatment, or a combination thereof. The membrane unit 600 can also include one or more spacers 312 to position and/or protect elements of the outer tubing 118. The one or more spacers 312 can also direct the aqueous solution stream 122 and/or the dissolved remediation gas solution 140 to the membrane-liquid interface.

In embodiments, the diffusion-based membrane can be configured where the gas is introduced to the aqueous solution stream 122 in the outer tubing 118 under a combination of countercurrent and cocurrent conditions described previously (not pictured). For example, in embodiments, a cocurrent configuration can be used for one or more membrane units further from the surface 124, to produce a higher mass transfer rate. A countercurrent setup can be simultaneously used for one or more membrane units to transport a return gas, which has low concentration of the desired gas at a part of the wellbore closer to the surface to facilitate higher gas removal efficiency.

In embodiments, the gas from the feed gas stream 126 can be concentrated in the gas chambers of the outer tubing 118 to form a concentrated gas solution. In embodiments, the concentrated gas solution can diffuse from the gas chambers of the outer tubing 118 to the liquid chambers of the outer tubing 118. In embodiments, the concentrated gas solution can dissolve in the aqueous solution stream 122 of the outer tubing 118 to form a dissolved remediation gas solution 140. In embodiments, the dissolved gas in the dissolved remediation gas solution 140 can be carried to a geological formation 112. The geological formation 112 can comprise an aquifer. Without intending to be bound by any particular theory, it is believed that the gas can diffuse from the gas chambers to the liquid chambers, driven by a gas phase concentration gradient between the gas chambers and the liquid chambers of the outer tubing 118. Further, it is believed that once the gas diffuses from the gas chambers of the outer tubing 118 and enters the liquid chambers of the outer tubing 118, soluble diffused gases can be dissolved in the aqueous solution stream 122 as the soluble diffused gases come in contact with the aqueous solution stream 122. It is believed that dissolution of the soluble diffused gases into the aqueous solution stream 122 that is flowing through the liquid chambers of the outer tubing 118 can create a local concentration gradient within the outer tubing 118 and can drive the diffusion process of the gas between the gas chambers and the liquid chambers of the outer tubing 118.

In embodiments, insoluble gases can diffuse through the diffusion membranes 310. However, as these gases don't dissolve in the aqueous solution stream 122, a concentration gradient of the insoluble gases may not be generated in the outer tubing 118. Without being bound by any particular theory, it is believed that the concentration of the insoluble gases can reach equilibrium inside the diffusion membranes, and diffusion of insoluble gases can be stopped or reduced when equilibrium is reached.

In embodiments, the liquid chambers of the outer tubing 118 can be fluidly connected to a geological formation 112. As used in this disclosure, the term “fluidly connected” refers to a configuration wherein fluids can flow from one component to another, but they need not be directly connected together. Without intending to be bound by any particular theory, it is believed that the aqueous solution stream 122 of the outer tubing 118 can dissolve remediation gas to form the dissolved remediation gas solution 140. In embodiments, the dissolved remediation gas solution 140 can carry a remediation gas to the geological formation 112. In embodiments, a portion of the remediation gas in the dissolved remediation gas solution 140 can be undissolved remediation gas. In embodiments, at least a portion of the undissolved remediation gas in the dissolved remediation gas solution 140 can be dissolved in the dissolved remediation gas solution 140 after the dissolved remediation gas solution exits the outer tubing 118. As injection of the dissolved remediation gas solution 140 into the geological formation continues, the remediation gas can be carried further into the formation where it transports the remediation gas into the geological formation 112. Without intending to be bound by any particular theory, it is believed the mass transfer mechanism for the remediation gas in the dissolved remediation gas solution 140 to the geological formation can be advection. Further it is believed the mass transfer mechanism can be dependent on an injection rate of the aqueous solution 136 into the wellbore 110, as the injection rate of the aqueous solution 136 can determine, in part, the injection rate of the dissolved remediation gas solution 140 into the formation.

In embodiments, a driving force of the diffusion of remediation gas from the gas chambers to the liquid chambers of the outer tubing 118 can be the concentration gradient, which drives the transfer of the remediation gas out of the gas chambers of the outer tubing 118 and into the liquid chambers of the outer tubing 118. As used herein the term “concentration gradient” refers to the gradual change in the concentration of solutes in a solution as a function of distance through a solution. Without intending to be bound by any particular theory, it is believed that several factors can affect the mass transfer rate of gases into the formation. It is believed that these factors can include the diffusion gradient inside the diffusion membranes (intermembrane diffusion) as well as the gradient in a film that forms at the surface of the diffusion membrane. As the diffusion gradient increases, the mass transfer rate can increase. The rate of solubility of the gas in the aqueous solution stream 122 at the membrane-liquid interface of the diffusion membrane 310 can also affect the mass transfer rate. For instance, as the rate of the solubility of the remediation gas in the aqueous solution stream 122 at the membrane-liquid interface increases, the mass transfer rate can increase. The intermembrane diffusion rate can be governed by a membrane diffusion coefficient and the concentration gradient between the gas inside the diffusion membrane 310 and the concentration of the gas in the dissolved remediation gas solution 140 at the exterior surface of the membrane-liquid interface. As the intermembrane diffusion rate increases, the mass transfer rate can increase. A film diffusion rate can be affected by a diffusivity of dissolved gas in the dissolved remediation gas solution 140. As the diffusivity of gas in the dissolved remediation gas solution 140 increases, the rate of mass transfer can increase. A liquid phase concentration gradient can be affected by the advective transport of the aqueous solution stream 122, which is governed by the water velocity, the water injection rate, or a combination thereof, among others. As the liquid phase concentration gradient increases, the rate of mass transfer can increase. As used herein, the term “advective transport” refers to the transport of a substance or material by bulk motion of a fluid. Gas to dissolved remediation gas solution 140 mass transfer can continue for as long as the concentration gradient is maintained between the gas chambers of the outer tubing 118 and the liquid chambers of the outer tubing 118.

In embodiments, the outer tubing 118 can be configured to receive gas under cocurrent conditions, countercurrent conditions, or a combination thereof, considering factors such as the remediation gas concentration, availability and cost of gas enrichment to increase concentration, composition of the remediation gas, availability of water for injection, energy requirement for injection vs concentration enrichment, among others. Other factors that may be considered are physical properties of the formation such as, but not limited to the concentration of pollutants in the aquifer, volume of the aquifer, porosity of the formation, permeability of the formation, or volume of the formation. For instance, in embodiments where the flow of the dissolved remediation gas solution into the geological formation 112 is relatively slow due to the low permeability of the geological formation 112, it may be advantageous to configure the outer tubing 118 to receive gas under countercurrent conditions to maximize the loading of the groundwater with remediation gas. However, other factors related to process optimization may have a greater impact on deciding the most efficient flow pattern, such as the gas composition and water pumping energy requirements. Without intending to be bound by any particular theory, it is believed that under conditions where a system is operating under favorable PTX (elevated pressure, low temperature, and high concentration of remediation gas) and high permeability, it can be advantageous to configure the outer tubing 118 to receive gas under cocurrent conditions and design for maximum mass transfer rate to transfer higher masses of remediation gases into the geological formation in a given time. However, under a cocurrent setup, the return gas can have an increased concentration of undissolved remediation gas. The undissolved gas can be enriched at the surface and reinjected into the wellbore. Accordingly, a cost-effective approach for system design can balance the number of wellbores (determined by PTX properties and permeability) against the cost of gas processing and enrichment facilities at the surface of the formation to determine a preferred operational setup of embodiments described herein.

In embodiments, the gas can be transported into the gas chambers of the outer tubing 118 within the wellbore 110 and the aqueous solution 136 can be transported into the wellbore 110 such that at least a portion of the aqueous solution 136 enters the liquid chambers of the outer tubing 118 as the aqueous solution stream 122. In embodiments, the gas and the aqueous solution 136 can be independently transported into the wellbore at a controlled rate to ensure efficient advective transport to carry dissolved gas into the formation. In embodiments, the dissolved gas can comprise O₂ and can be transported inside a geological formation comprising an aquifer for groundwater remediation.

In embodiments, the dissolved remediation gas solution 140 within the outer tubing 118 can exit the wellbore 110 through a formation conduit, such as the open-hole portion 116 of the wellbore 110. In embodiments, the dissolved remediation gas solution 140 can flow into a surrounding formation, such as the geological formation 112 comprising the aquifer.

In embodiments, the liquid chambers of the outer tubing 118 can be flushed with an aqueous solution stream 122 that is not saturated with the remediation gas. Without intending to be bound by any particular theory, it is believed that continuously flushing the liquid chambers of the outer tubing 118 with the aqueous solution stream 122 can increase the mass transfer rate of remediation gas into the geological formation 112. Further, it is believed that flushing the liquid chambers of the outer tubing 118 with an aqueous solution stream 122 having a lower dissolved gas content can result in a greater mass transfer rate.

In embodiments, the gas in the dissolved remediation gas solution 140 can be fluidly connected with the aquifer, such that the remediation gas solution 140 decreases a concentration of pollutants in the aquifer.

In embodiments, at least a portion of undissolved remediation gas within the outer tubing 118 can be transported to the surface 124 of the geological formation 112, and a composition and/or concentration of the undissolved remediation gas can be monitored. In embodiments, the undissolved remediation gas can flow out of the outer tubing 118 and be transported to the surface 124 through a gas return pipe 146. The composition and concentration of the undissolved remediation gas flowing out of the outer tubing 118 can be monitored to assess the efficiency of gas dissolution into the aqueous solution stream 122. Without intending to be bound by any particular theory, it is believed that a greater amount of undissolved remediation gas detected at the surface 124 of the geological formation 112 suggests less efficient dissolution of gas in the aqueous solution stream 124. Further, it is believed that by monitoring a concentration of the undissolved remediation gas at the surface 124, the amount, or rate of remediation gas transferred into the formation can be calculated. For instance, the amount of undissolved remediation gas at the surface 124 can be subtracted from the amount of remediation gas injected into the wellbore to provide an amount of remediation gas that enters the geological formation for sequestration.

In embodiments, the concentration of the gas into the geological formation can be increased by changing the operation conditions. Without intending to be bound by any particular theory, it is believed that the concentration of the remediation gas in the geological formation is dependent on a gas concentration in the feed gas stream 126, an aqueous solution 136 transport rate, a permeability of the diffusion membranes 310, and the pressure, the temperature and the composition of the aqueous solution 136 that is added to the wellbore. For instance, if the concentration of the remediation gas in the feed gas stream 126 is increased, the concentration of the remediation gas in the formation can increase. If the aqueous solution 136 transport rate increases, the concentration of the remediation gas in the formation can increase as this can increase the concentration gradient between the gas chambers and liquid chambers of the outer tubing 118. As the permeability of the diffusion membranes 310 increase, the concentration of the remediation gas in the geological formation can increase. As pressure, temperature, or both pressure and temperature of the aqueous solution 136 injected into the wellbore 110 increases, the concentration of the gas in the formation can increase. In embodiments, as the concentration of the remediation gas in the geological formation increases, the mass-transfer rate of the remediation gas into the geological formation increases.

In embodiments, a flow rate of the remediation gas, a flow rate of the aqueous solution 136, a pressure of the remediation gas, a pressure of the aqueous solution 136, a gas concentration in the feed gas stream 126, or combination of two or more can be independently changed so as to increase a concentration of the remediation gas in the dissolved remediation gas solution 140, as determined by the monitoring of the undissolved remediation gas. In embodiments, a composition of the aqueous solution 136 within the geological formation 112 can be monitored to determine what adjustments can be made to increase a concentration of the remediation gas in the dissolved remediation gas solution 140.

In embodiments, the remediation gas can enter the outer tubing 118 under cocurrent conditions, countercurrent conditions, or both cocurrent conditions and countercurrent conditions, as described herein.

In embodiments, the undissolved gases can comprise O₂, O₃, H₂, any other remediation gases, or combinations of these. In embodiments, Ar₂ can be added to the feed gas stream 126 and enter the outer tubing 118 to monitor the rate of mass transfer. For instance, Ar₂ is soluble and inert, so monitoring the Ar₂ concentration can provide an estimate of the mass transfer rate independent of any reaction that takes place inside the geological formation. Other water soluble and inert gases that could help monitoring of the mass transfer rates of the remediation gases include, but are not limited to, SF₆, SF₅, or CF₃.

In embodiments, the rates of consumption of remediation gas inside the geological formation 112 (and hence the effectiveness of the groundwater remediation system) can be estimated by the co-injection of conservative soluble gases such as SF₆, SF₅, CF₃, or conservative tracer liquids such as sodium fluoresceine, sulphothdamine, and other similar chemical compounds. Measuring the concentrations of those inert substances along with that of the remediation gases in monitoring wells downstream of the injection well can help accurately estimate the rates of remediation gas consumption. In addition, monitoring of the physical properties (pH, EC, density) and chemical and/or isotope compositions of groundwater samples collected from the same monitoring wells can be used to determine the extent and progression of the remediation reactions. This information can be used to optimize pollutant degradation by adjusting the mass of the remediation gas delivered in the geological formation 112 by modifying gas transfer rates or mass transfer methods (e.g. cocurrent vs. countercurrent, etc.), drilling new injection and/or water production wells, among others.

In embodiments, a portion of the gas from the gas source 128 can include insoluble gases to maintain a desired pressured within the outer tubing 118. For instance, a high differential pressure between the gas chambers of the outer tubing 118 and the liquid chambers of the outer tubing 118, or a high differential pressure between two or more portions of the membrane can result in collapse of the membrane. In embodiments, the insoluble gases can include N₂.

In embodiments, a concentration and/or composition of the aqueous solution 136 within the formation can be monitored. In embodiments, the aqueous solution 136 within the formation can be transported to the surface 124 as a return water stream and the composition of the return water stream can be analyzed. For example, the detection of dissolved gas, such as O₂ in the return water stream can indicate a plume of O₂-rich water has begun to reach the aqueous solution source 138. By monitoring a rate of the dissolved O₂ concentration in the return water stream, a determination of the desired capacity for additional O₂, or other remediation gases, can be made. In embodiments, an aqueous solution downstream of the aqueous solution 136 within the formation may be monitored and the composition of the aqueous solution downstream of the aqueous solution 136 can be analyzed. Additionally, when transporting the dissolved remediation gas solution 140 into the reactive formation 112, the concentration of a target gas in the outer tubing 118 can be changed by adjusting the gas source 128 settings, gas pump 130 settings, or a combination of the gas source 128 and gas pump 130 settings, such as flow rate and pressure. The concentration of a target gas in the outer tubing 118 can be changed to adjust the mass transfer rate of the target gas in the formation.

In embodiments, methods can be used to separate undesired impurities in the feed gas stream 126 before introducing the gas to the inner tubing 120. In embodiments, methods can be used to modify PTX properties of the aqueous solution 136. Non-limiting examples to modify the pressure, temperature, composition, or combinations thereof of the aqueous solution 136 can include target gas enrichment methods such as amine absorption/adsorption, pressure swing adsorption, cryogenic separation, or other methods that may result in a change of the PTX properties of the aqueous solution 136.

In embodiments, the systems and methods disclosed herein may remediate an aquifer by delivering a remediation gas to the aquifer, thereby increasing the removal of pollutants from the aquifer through microbial-mediated reactions. In embodiments, remediation may also occur through inorganic (chemical) reactions

Embodiments herein may be useful over a range of formation conditions, including temperatures from greater than 0° C. to less than 80° C., and pressures from 100 kilopascals (kPa) to less than 10,000 kPa, which may be encountered in shallow unconfined aquifers, where the bulk of groundwater pollution occurs. Without intending to be bound by any particular theory, it is believed that at temperatures less than 0° C., the reaction rates of remedial processes may be slower than desired. Further, it is believed that temperatures above 80° C., the efficacy of biological degradation of pollutants may decrease significantly at temperatures greater than 80° C. Moreover, such PT conditions are not only uncommon in unconfined aquifers, but if encountered (e.g., in geothermal areas) may also result in groundwater boiling, which may partition the remediation gas into the boiling gas phase, which may exit the formation. In embodiments, the systems and methods disclosed herein may be also be applied to deep confined aquifers at pressures higher than 10,000 KPa, provided that the temperature is conducive of microbial processes.

Some conventional mass transfer technologies used for groundwater remediation include pumping contaminated water to the surface of a geological formation, bubble aeration of O₂ in the contaminated water at the surface, and reinjection of the treated water into the aquifer. These conventional methods can have increased operational costs as they require pumping the entire volume of the contaminated water to the surface to be treated, and bubble aeration is inefficient for dissolving remediation gases, such as O₂ into the contaminated water. Further, these methods may require compressing the remediation gas before bubble aeration, which can also increase the operational cost. The inefficient mass transfer of O₂ to water caused by the less than optimal mass transfer effectiveness of conventional processes such as bubble aeration could add significantly to the operational costs. Therefore, any process that can improve the effectiveness of remediation gas dissolution and in-situ remediation, such as embodiments disclosed herein, can significantly improve the economics of groundwater remediation.

Embodiments disclosed herein can optimize the dissolution of remediation gases, such as but not limited to O₂, in an aqueous solution for the purpose groundwater remediation in a geological formation; reduce the energy cost of compressing gas or gas mixtures, while maintaining the same level of gas concentration in the aqueous solution; optimize O₂ or other gas uptake in a formation using a formation conduit in the wellbore; reduce the aqueous solution injection volume required; and improve process rate control and efficiency by monitoring return gas composition and aqueous solution stream composition, among other benefits.

A first aspect of the present disclosure is directed to a system for groundwater remediation in a geological formation comprising a wellbore disposed within the geological formation, the geological formation comprising an aquifer; a casing disposed within the wellbore; inner tubing centrally disposed within the wellbore and extending downhole a depth within the wellbore, the inner tubing being a pathway for remediation gas; a water passage, the water passage being a pathway for delivering an aqueous solution; outer tubing in fluid communication with and disposed about the inner tubing, the outer tubing comprising a plurality of chambers and a plurality of diffusion membranes disposed proximate or within the chambers, wherein the diffusion membranes are configured to selectively permit remediation gas flow into an aqueous solution stream comprising at least a portion of the aqueous solution flowing within the outer tubing to thereby facilitate dissolution of the remediation gas within the aqueous solution; and a formation conduit in fluid communication with the aquifer, configured to deliver the solution of dissolved remediation gas in the aqueous solution stream to the aquifer for groundwater remediation.

A second aspect of the present disclosure may include the first aspect, wherein the outer tubing is positioned within the casing disposed within the wellbore.

A third aspect of the present disclosure may include either one of the first or second aspects, further comprising a plurality of spacers disposed proximate or within the outer tubing.

A fourth aspect of the present disclosure may include any one of the first through third aspects, wherein a membrane unit comprises a portion of the outer tubing and the plurality of membrane units are connected in series between adjacent chambers.

A fifth aspect of the present disclosure may include any one of the first through fourth aspects, wherein the diffusion membranes are disposed along an outer surface of the chambers adjacent the water passage.

A sixth aspect of the present disclosure may include any one of the first through fifth aspects, wherein the diffusion membranes comprise silicone, polydimethylsiloxane, or combinations thereof.

A seventh aspect of the present disclosure may include any one of the first through sixth aspects, wherein the water passage is disposed proximate an interior surface of the wellbore and extending downhole a depth within the wellbore.

An eighth aspect of the present disclosure may include any one of the first through seventh aspects, further comprising an aqueous solution source within the aquifer in fluid communication with the water passage.

A ninth aspect of the present disclosure may include any one of the first through eighth aspects, further comprising a water pump disposed between the aqueous solution source and the water passage.

A tenth aspect of the present disclosure may include any one of the first through ninth aspects, further comprising a gas pump in communication with the inner tubing.

An eleventh aspect of the present disclosure may include any one of the first through tenth aspects, further comprising a gas return passage disposed between the outer tubing and a surface of the geological formation, the gas return passage being a pathway for undissolved gases in the outer tubing to reach the surface of the geological formation.

A twelfth aspect of the present disclosure may include any one of the first through eleventh aspects, wherein the formation conduit comprises an unlined portion of the wellbore at a downhole end of the formation conduit.

A thirteenth aspect of the present disclosure may include any one of the first through twelfth aspects, wherein the outer tubing is disposed within the unlined portion of the wellbore.

A fourteenth aspect of the present disclosure may include any one of the first through thirteenth aspects, wherein the outer tubing is disposed within both the casing and the unlined portion of the wellbore.

A fifteenth aspect of the present disclosure is directed to a method of groundwater remediation in a geological formation comprising: forming a dissolved remediation gas solution within a wellbore by: passing remediation gas through an inner tubing, passing an aqueous solution into the wellbore through a water passage and an outer tubing comprising a plurality of diffusion membranes, and passing the remediation gas through the diffusion membranes to be mixed with the aqueous solution in the outer tubing to produce the dissolved remediation gas solution; and transporting at least a portion of the dissolved remediation gas solution to an aquifer within the geological formation.

A sixteenth aspect of the present disclosure may include the fifteenth aspect, further comprising: transporting at least a portion of undissolved remediation gas within the outer tubing to a surface of the geological formation; and monitoring a composition and concentration of the undissolved remediation gas, a composition and concentration of the aqueous solution, or both.

A seventeenth aspect of the present disclosure may include the sixteenth aspect, further comprising increasing a gas flow rate of the remediation gas into the wellbore to increase a concentration of the remediation gas in the dissolved remediation gas solution, as determined by the monitoring of the undissolved remediation gas transported to the surface of the geological formation, the aqueous solution, or both.

An eighteenth aspect of the present disclosure may include the sixteenth aspect or the seventeenth aspect, further comprising changing an aqueous solution flow rate of the aqueous solution into the wellbore to increase a concentration of the remediation gas in the dissolved remediation gas solution, as determined by the monitoring of the undissolved remediation gas transported to the surface of the geological formation, the aqueous solution, or both.

A nineteenth aspect of the present disclosure may include any one of the fifteenth through eighteenth aspects, further comprising transporting at least a portion of aqueous solution within the geological formation to a surface of the geological formation; and monitoring a composition and concentration of the aqueous solution.

A twentieth aspect of the present disclosure may include any one of the fifteenth through nineteenth aspects, wherein the remediation gas enters the outer tubing under cocurrent conditions, countercurrent conditions, or both cocurrent conditions and countercurrent conditions.

A twenty first aspect of the present disclosure may include any one of the fifteenth through twentieth aspects, wherein the dissolved remediation gas solution comprises O₂, O₃, H₂, or combinations thereof.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of,” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

What is claimed is:

1. A system for groundwater remediation in a geological formation comprising:
a wellbore disposed within the geological formation, the geological formation comprising an aquifer;
a casing disposed within the wellbore;
inner tubing centrally disposed within the wellbore and extending downhole a depth within the wellbore, the inner tubing being a pathway for remediation gas;
a water passage, the water passage being a pathway for delivering an aqueous solution;
outer tubing in fluid communication with and disposed about the inner tubing, the outer tubing comprising a plurality of chambers and a plurality of diffusion membranes disposed proximate or within the chambers, wherein the diffusion membranes are configured to selectively permit remediation gas flow into an aqueous solution stream comprising at least a portion of the aqueous solution flowing within the outer tubing to thereby facilitate dissolution of the remediation gas within the aqueous solution; and
a formation conduit in fluid communication with the aquifer, configured to deliver the solution of dissolved remediation gas in the aqueous solution stream to the aquifer for groundwater remediation.

2. The system of claim 1, wherein the outer tubing is positioned within the casing disposed within the wellbore.

3. The system of claim 1, wherein a membrane unit comprises a portion of the outer tubing and the plurality of membrane units are connected in series between adjacent chambers.

4. The system of claim 1, wherein the diffusion membranes are disposed along an outer surface of the chambers adjacent the water passage.

5. The system of claim 1, wherein the diffusion membranes comprise silicone, polydimethylsiloxane, or combinations thereof.

6. The system of claim 1, wherein the water passage is disposed proximate an interior surface of the wellbore and extending downhole a depth within the wellbore.

7. The system of claim 1, further comprising an aqueous solution source within the aquifer in fluid communication with the water passage.

8. The system of claim 7, further comprising a water pump disposed between the aqueous solution source and the water passage.

9. The system of claim 1, further comprising a gas pump in communication with the inner tubing.

10. The system of claim 1, further comprising a gas return passage disposed between the outer tubing and a surface of the geological formation, the gas return passage being a pathway for undissolved gases in the outer tubing to reach the surface of the geological formation.

11. The system of claim 1, wherein the formation conduit comprises an unlined portion of the wellbore at a downhole end of the formation conduit.

12. The system of claim 1, wherein the outer tubing is disposed within the unlined portion of the wellbore.

13. The system of claim 1, wherein the outer tubing is disposed within both the casing and the unlined portion of the wellbore.

14. A method of groundwater remediation in a geological formation comprising:
forming a dissolved remediation gas solution within a wellbore by:
passing remediation gas through an inner tubing;
passing an aqueous solution into the wellbore through a water passage and an outer tubing comprising a plurality of diffusion membranes; and
passing the remediation gas through the diffusion membranes to be mixed with the aqueous solution in the outer tubing to produce the dissolved remediation gas solution; and
transporting at least a portion of the dissolved remediation gas solution to an aquifer within the geological formation.

15. The method of claim 14, further comprising:
transporting at least a portion of undissolved remediation gas within the outer tubing to a surface of the geological formation; and
monitoring a composition and concentration of the undissolved remediation gas, a composition and concentration of the aqueous solution, or both.

16. The method of claim 15, further comprising increasing a gas flow rate of the remediation gas into the wellbore to increase a concentration of the remediation gas in the dissolved remediation gas solution, as determined by the monitoring of the undissolved remediation gas transported to the surface of the geological formation, the aqueous solution, or both.

17. The method of claim 15, further comprising changing an aqueous solution flow rate of the aqueous solution into the wellbore to increase a concentration of the remediation gas in the dissolved remediation gas solution, as determined by the monitoring of the undissolved remediation gas transported to the surface of the geological formation, the aqueous solution, or both.

18. The method of claim 14, further comprising:
transporting at least a portion of aqueous solution within the geological formation to a surface of the geological formation; and
monitoring a composition and concentration of the aqueous solution.

19. The method of claim 14, wherein the remediation gas enters the outer tubing under cocurrent conditions, countercurrent conditions, or both cocurrent conditions and countercurrent conditions.

20. The method of claim 14, wherein the dissolved remediation gas solution comprises O₂, O₃, H₂, or combinations thereof.
